(19) United States
(12) Patent Application Publication
(10) Pub. No.: US 2024/0189178 A1
(43) Pub. Date: Jun. 13, 2024

(54) SYSTEM AND METHOD FOR DISPLACING OR REFORMING A MASS WITHIN A BODY MEDIUM

(71) Applicant: WOOJER LTD., Elad (IL)

(72) Inventors: Mor Efrati, Tel Aviv (IL); Uri KAREEV, Tel Aviv (IL); Kfir BARLEVAV, Elad (IL); Noam BARLEVAV, Kfar Saba (IL)

(73) Assignee: WOOJER LTD., Elad (IL)

(21) Appl. No.: 18/287,688

(22) PCT Filed: Apr. 27, 2022
(86) PCT No.: PCT/IL2022/050426

§ 371 Date: Oct. 20, 2023

Related U.S. Application Data
(60) Provisional application No. 63/180,253, filed on Apr. 27, 2021.

(51) Int. Cl. A61H 23/02

(52) U.S. Cl. CPC A61H 23/0236; A61H 2201/0138; A61H 2201/1207; A61H 2201/14; A61H 2201/165; A61H 2201/5005; A61H 2201/5007

(57) ABSTRACT

A system and method for displacing or reforming a mass within a body medium. The system includes one or more tactile audio transducers. A processor is configured to generate signals that drive the transducers in to generate audio waves in the medium when the transducers are applied to the medium and cause displacement of the mass or reformation of the mass. The method includes applying one or more tactile audio transducers to the medium; and driving one or more of the tactile audio transducers to generate audio waves in the medium to cause displacement of the mass or reformation of the mass.

### FIELD OF THE INVENTION

The present invention relates to medical devices, and more specifically to such devices for applying mechanical energy into a body.

### BACKGROUND OF THE INVENTION

The following prior art publication is considered as being relevant for an understanding of the background of the invention:
U.S. Pat. No. 5,235,967 to Arbisi et al.

There are various medical conditions where applying haptic tactile energy to a body surface may have beneficial effects. For example, it is known to apply a peristaltic pressure effect to the legs in cases of edema in order to promote flow of lymph towards the trunk. As another example, cystic fibrosis has been treated by pounding the back of a patient to promote movement of mucus up the bronchial tree towards the larynx.

Various wearable devices are known that apply haptic tactile energy to a body surface. Such wearable devices may be, for example, in the form of a vest worn over the torso or a sleeve worn over a body limb. These wearable devices may apply haptic tactile energy to the individual for example, using one or more bladders that are cyclically inflated and deflected to generate a pounding motion on the thorax. Other wearable devices use one or more transducers to transmit pressure waves to the thorax. Wearable devices are also known that administer mechanical impacts or vibrations to the thorax. These devices include one or more electro-mechanical vibrators to produce pulsating impacts. U.S. Pat. No. 5,235,967 to Arbisi et al, describes a vest-like garment with a plurality of movable electrically conductive elements that are actuated by a pulsed magnetic field produced by drive coils that are energized by a drive circuit.

An audio transducer (also known as a “tactile transducer”) is a device that generates vibrations into various body surfaces. frequencies can be felt as well as heard by an individual, a phenomenon sometimes referred to as “tactile sound”.

Existing systems use either air waves or motors or speakers to induce vibration. However, these prior art systems do not use lossless tactile haptic induction, by directly applying the inductors on the patient or via a rigid lossless mechanical extension, and do not use designed asymmetrical waveforms or a combination of symmetrical and asymmetrical waves to move and control the movement of masses and materials within the body.

### SUMMARY OF THE INVENTION

The present invention provides a system and method for displacing or reforming a body mass within the body. The invention may be used, for example, to displace a blood clot in an occluded blood vessel, to displace mucus within the respiratory tract in cases of cystic fibrosis, to displace a food bolus in the digestive tract in cases of impaired digestive tract peristalsis, or movement of lymph valves in cases of edema. The inventors have found that generating synchronized symmetric or asymmetric sound waveforms in the tissue surrounding the mass can create displacement of the mass. As used herein the term “asymmetric wave” is used to refer to a waveform wherein the wave and its inverse are not identical, such as for example either. Such asymmetric waveforms may be created, for example, by (1) one or more transducers executing a cycle with a rapid buildup of pressure followed by a slower release of pressure, (2) a wave train in which a first time interval of constant pressure is followed by a second time interval of less pressure, or (3) where the buildup of the wave is complex comprising a modulated attack form and modulated release.

The invention comprises a device including one or more tactile audio transducers where each tactile audio transducer can be applied to a specific location on a body surface or tissue in a specific orientation so that each tactile audio transducer delivers tactile haptic energy pressure cycles to a specific location in the body. The system may be, for example, in the form of a wearable device such as a vest adapted to be worn around the torso, or a sleeve adapted to be worn on a body limb, or a system of one or more implanted transducers applying the haptic stimuli directly from within the body. The system may be embedded into an object to which a body part of the user is applied, for example, a piece of furniture such as a chair, a bed or a mattress.

The system may further comprise a controller that activates the transducers in a predetermined pattern to generate a temporo-spatial array of transducer activation. As explained below, the temporo-spatial array of the transducer activation and the transducer orientation may be selected to generate directional waves in the targeted body tissue to displace or reform the mass.

Due to the proven relationship between the mental wellbeing of an individual and his or her physical state, the invention may be combined with entertainment media, to allow the individual being treated by the invention to be entertained and have a pleasant experience during the treatment, thus allowing a better overall medical procedure. This is of high importance to patients with chronic diseases for whom treatment is a part of their routine.

Thus, in one of its aspects, the present invention provides a system for displacing or reforming a mass within a body medium comprising:
(a) one or more tactile audio transducers;
(b) a processor configured to generate signals that drive the transducers in a predetermined fashion to generate audio waves in the medium when the transducers are applied to the medium and cause displacement of the mass or reformation of the mass.

The transducers may be adapted to be applied to a surface overlying the medium or embedded or implanted in the medium.

One or more of the audio waves may be a symmetric wave. One or more of the audio waves may be an asymmetric wave selected from:
(a) a waveform having a rapid buildup of pressure followed by a slower release of pressure;
(b) a wave train in which a first-time interval of constant first pressure is followed by a second time interval of a second pressure, the second pressure being lower than the first pressure. and
(c) a waveform in which buildup of the wave is complex and comprises a modulated attack form and modulated release.

The transducers may be positioned in an array to produce a synergetic effect on the mass to focus the waves on the mass, or to induce directional movement of the mass.

The transducers may be incorporated into a wearable device or may be embedded in a furniture item.

One or more of the transducers may be adapted to be positioned separated from the body, and the system further comprises one or more rigid elements that convey the audio waves from the transducer to the medium.

One or more of the signals may include entertainment media.

The system may comprise a single transducer.

One or more of the transducers may be adapted to be applied onto the medium.

One or more of the transducers may be adapted to be applied onto a body surface and one or more of the transducers may be activatable to generate the waves in a direction parallel to the body surface. or perpendicular to the body surface.

The system may be configured to activate the transducers at two or more frequencies and waveforms to maintain or manipulate the medium or materials within the medium.

In another of its aspects, the present invention provides a method for displacing or reforming a mass within a body medium comprising:
(a) applying one or more tactile audio transducers to the medium; and
(b) driving one or more of the tactile audio transducers to generate audio waves in the medium to cause displacement of the mass or reformation of the mass.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows a system for applying haptic/tactile audio energy to a body surface in accordance with one embodiment of the invention;

FIG. 2a shows the front and FIG. 2b shows the back of a wearable device in the form of a vest for delivering haptic tactile audio energy to a body surface that may be used in the system of FIG. 1;

FIG. 3 shows a wearable device in the form of a sleeve for delivering haptic/tactile audio energy to a body surface or organ that may be used in the system of FIG. 1;

FIG. 4 shows an exploded expanded view of a wearable device that may be used in the system of FIG. 1;

FIG. 5A and FIG. 5B show two exemplary configurations with the respective effect on signal levels;

FIG. 6 shows symmetric and asymmetric signals that may be used in the invention to generate various in body effects; and

FIG. 7 shows an exemplary configuration capable of creating a displacement of an in-body mass along a designated direction, in accordance with one embodiment of the invention.

### DESCRIPTION OF THE INVENTION

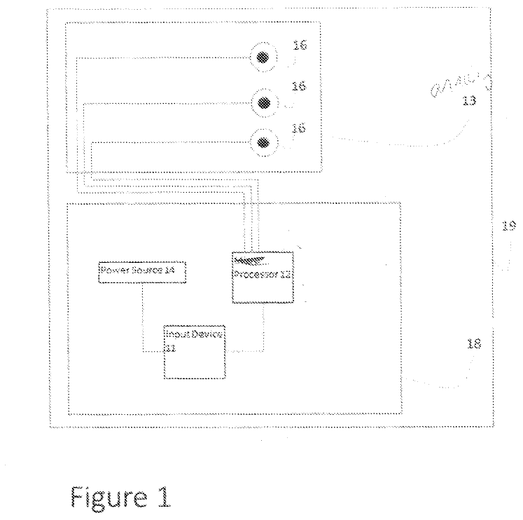

FIG. 1 shows a schematic view of a system 19 for displacing or reforming a body mass within the body in accordance with one embodiment of the invention. The system 19 includes a an array 13 of one or more transducers The system 19 also includes a control unit 18. The control unit 18 comprises a power source 14, a processor 12, and an input device 11 such as a keyboard or control panel. The power source 14 may be, for example, a rechargeable battery or means for connection to an AC power source.

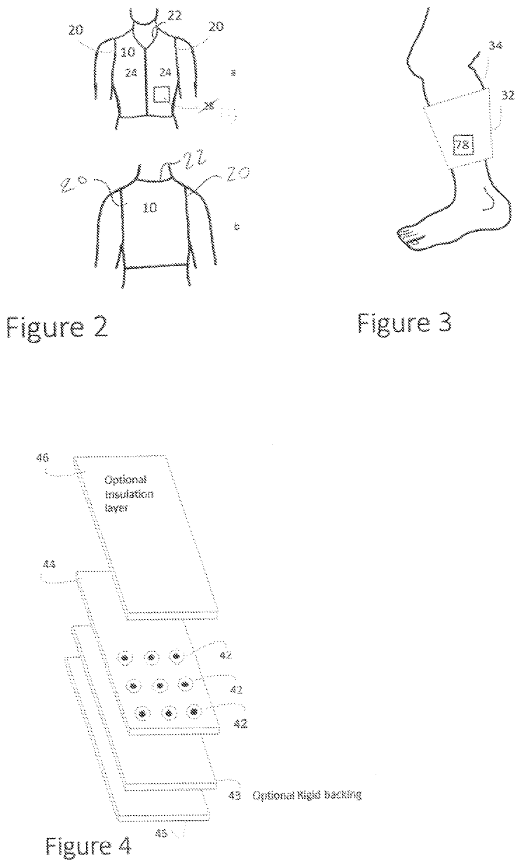

FIG. 2 shows a first example of a device that may be used in the system 19 of the invention. The device shown in FIG. 2 is in the exemplary form of a vest 10 that is worn around the torso and may be used, for example, in the treatment of cystic fibrosis or impaired digestive tract motility. FIG. 2a shows the front and FIG. 2b shows the back of the vest 10. The vest 10 includes a pair of arm openings 20 and a neck opening 22. Front flaps 24 of the vest 10 can be secured together by separable fasteners that allow the device to be put on and taken off as needed. The controller 18 may be contained in a pouch 28 that may be, for example, attached to the outer surface of the vest 10 or mounted on a belt.

FIG. 3 shows as another example, a wearable device 78 that may be used in the system 19 of the invention. The wearable device 78 shown in FIG. 2 is in the form of a sleeve 32 configured to be worn on a body limb 34 such as a leg or an arm, that may be used, for example, in the treatment of edema.

FIG. 4 shows an expanded view of the layers of a wearable the device (such as the vest 10 or the sleeve 32) that may be used in the system of the invention. An innermost layer 45 consists of a sheet of a flexible fabric material that is applied, directly or indirectly, to a body surface to be treated. A frame 44 supports one or more haptic low frequency tactile audio transducers 42.

An optional rigid backing 43 is positioned behind the frame 44 that opposes the motion of the transducers 42, so that movement of the transducers is confined to the space between the frame 44 and the body surface. Behind the rigid backing 43 is an outermost layer 45 that may be made from the same material as the innermost layer 46.

The input device 11 allows programing of the processor 12 including, for example, specifying the characteristics of the operation of each transducer and the pattern of transducer activation. One or more of the transducers may execute an asymmetric cycle or waveform, in which the impact stroke of the cycle is different from the recovery stroke. For example, one or more of the transducers may execute a cycle with a rapid buildup of pressure followed by a slower release of pressure, or an impulse in which a first-time interval of constant pressure is followed by a second time interval of. less pressure. The input device 11 may also allow specification of the haptic stimulation, the frequency and amplitude of each transducer and or selection of other media that are also to be used in the stimulation.

The processor 12 may be further configured to execute a temporo-spatial array of transducer activity that is selected to create a synergetic effect between the transducers in the array to induce directional displacement waves in the body tissue underlying the transducer array.

In the case that it is desired to move the mass 78 from the position P1 in the direction of the arrow 78, the two transducers 72 and 73 may be activated simultaneously, each of the two transducers 72 and 73 may execute a symmetric or asymmetric cycle to displace the mass 71 within the medium 70. If the mass 78 is confined to the body tube 76, displacement of the mass 71 will be along the tube 76 in the direction of the arrow 78. If the mass 71 is not confined to a body tube, displacement of the mass 71 can be directed in the direction of the arrow 78 by activating the transducers 74 and 75 in a way that is symmetric and synchronized with the transducers 72 and 73. When the mass 71 has arrived at the position P2, the process may be repeated by activation of the transducers 74 and 75 as just explained for the transducers 72 and 73. The process may be repeated any number of times until the mass 71 has arrived at its final destination.

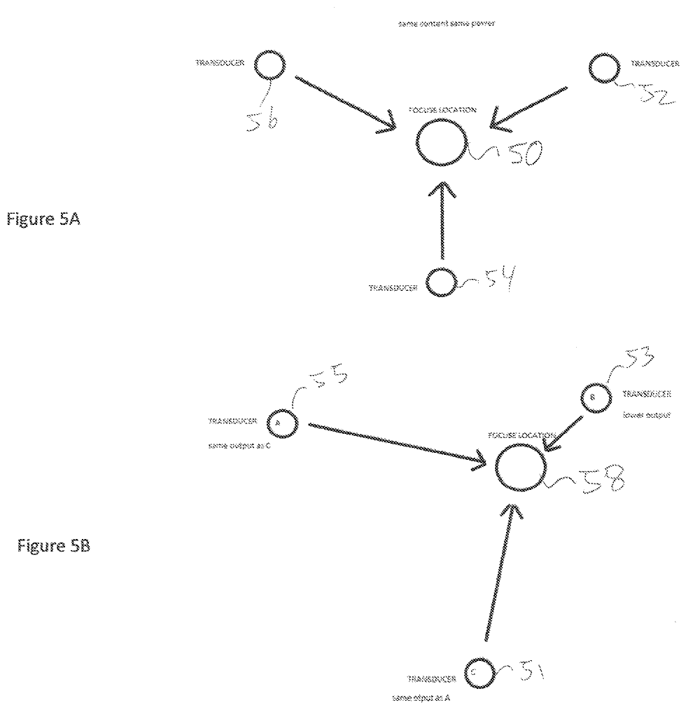

FIG. 5 shows two different location configurations and exemplary modifications to the actuation of the transducer driving signals to achieve a desired effect. In FIG. 5a, a focal area 50 is located equidistant from transducers 52, 54, and 56 so that the three transducers 52, 54, and 56 could be operated at the same amplitude. In FIG. 5B, the focal point 58 is closest to the transducer 53, so the amplitude of the signal driven to the transducer 53 could be lower than the signal amplitude driven to transducers 51 and 55.

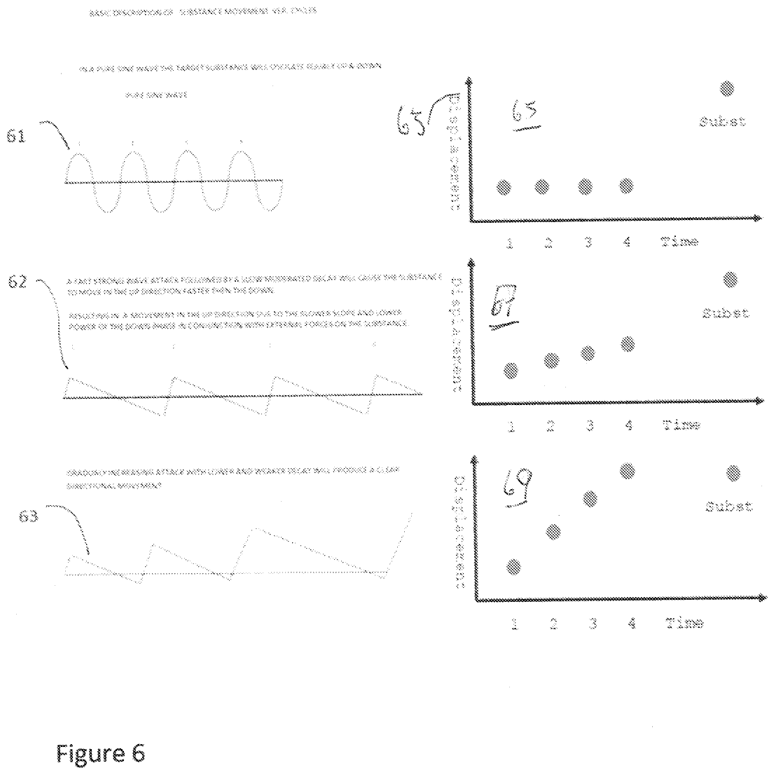

FIG. 6 shows exemplary and non-limiting waveforms that may be used to create desired effects on a mass within a body. Waveform 61 is a symmetrical waveform. A mass subjected to waveform 61 will oscillate equally in opposite directions, as indicated in graph 65. This oscillation can potentially have benefits such as material separation (e.g. separation of mucus in the lungs), material alignment into geometric forms or breakdown but without causing directional displacement of the mass.

Waveform 62 shows an exemplary and non-limiting asymmetrical waveform comprising a steep rising edge with a slower falling edge, resulting in gradual pushing waves in one direction relative to the transducer. Such waveforms may result in a gradual directional push of the mass, as indicated in graph 67.

Waveform 63 shows an exemplary and non-limiting asymmetrical waveform comprising of a steep rising edge with a slower falling edge in a cyclically increasing amplitude, resulting in pushing waves, as indicated in graph 69, that are stronger than those depicted in the graph 67, and are in one direction relative to the transducer. Such waveforms may result in a gradual directional push of the mass.

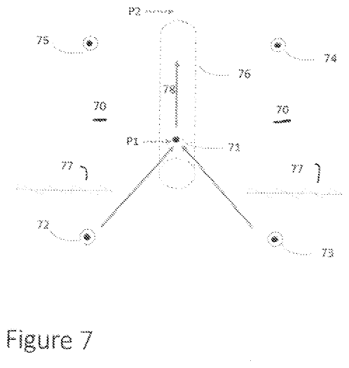

FIG. 7 shows schematically a body mass 71 present in a body tissue 70, referred to herein as “the medium”. The mass 71 may or may not be confined to a tube 76, such as a blood vessel or bronchus. FIG. 7 also shows four transducers 72, 73, 74, and 75, positioned in an array designed to generate waves in the medium that are focused on the mass or in the medium. The transducers 72, 73, 74, and 75 may or may not be part of a larger transducer array. The transducers 72, 73, 74, and 75 may be embedded in the medium 70 or applied to a surface overlying the medium 70.

In the case that it is desired to move the mass 71 from the position P1 in the direction of the arrow 78, the two transducers 72 and 73 may be activated simultaneously creating a push waveform such as the waveform 77, each of the two transducers 72 and 73 may execute a symmetric or an asymmetric cycle to displace the mass 71 within the medium 70. The transducers 74 and 75 may be further configured to create weak waveforms to help steering the mass towards P2. If the mass 71 is confined to the body tube 78, displacement of the mass 71 will be along the tube 76 in the direction of the arrow 78. If the mass 71 is not confined to a body tube, displacement of the mass 71 can be directed in the direction of the arrow 78 by activating the transducers 74 and 75 in a way that is symmetric and synchronized with the transducers 72 and 73. When the mass 71 has arrived at the position P2, the process may be repeated by activation of the transducers 75 and 75, as just explained for the transducers 72 and 73. The process may be repeated any number of times until the mass 71 has arrived at its final destination. Transducers 74 and 75 may also be used to induce an additional waveform that manipulate the medium or other materials in the medium to assist with the process.

1. A system for displacing or reforming a mass within a body medium comprising:
(c) one or more tactile audio transducers;
(d) a processor configured to generate signals that drive the transducers in a predetermined fashion to generate audio waves in the medium when the transducers are applied to the medium and cause displacement of the mass or reformation of the mass.

2. The system according to claim 1, wherein one or more of the transducers are adapted to be applied to a surface overlying the medium.

3. The system according to claim 1, wherein one or more of the transducers are adapted to be embedded or implanted in the medium.

4. The system according to claim 1, wherein one or more of the audio waves is a symmetric wave.

5. The system according to claim 1, wherein one or more of the audio waves is an asymmetric wave selected from one of the group consisting of:
(d) a waveform having a rapid buildup of pressure followed by a slower release of pressure;
(e) a wave train in which a first time interval of constant first pressure is followed by a second time interval of a second pressure, the second pressure being lower than the first pressure. and
(f) a waveform in which buildup of the wave is complex and comprises a modulated attack form and modulated release.

6. The system according to claim 1, comprising a plurality of transducers wherein the transducers are positioned in an array producing a synergetic effect on the mass based on relative positions of the transducers in order to focus the waves on the mass.

7. The system according to claim 1, comprising a plurality of transducers wherein the transducers are positioned in an array producing a synergetic effect on the mass based on relative positions of the transducers applying asymmetric waveforms in order to induce directional movement of the mass.

8. The system of according to claim 1, wherein the transducers are incorporated into a wearable device.

9. The system according to claim 1, wherein one or more of the transducers are adapted to be positioned separated from the body, and the system further comprises one or more rigid elements that convey the audio waves from the transducer to the medium.

10. The system according to claim 1, wherein one or more of the signals include entertainment media.

11. The system according to claim 1, comprising a single transducer.

12. The system according to claim 1, wherein one or more of the transducers are embedded in a furniture item.

13. The system of claim 1, wherein one or more of the transducers are adapted to be applied onto the medium.

14. The system according to claim 1, wherein one or more of the transducers are adapted to be applied onto a body surface and one or more of the transducers is activatable to generate the waves in a direction parallel to the body surface.

15. The system according to claim 1, wherein one or more of the transducers are adapted to be applied onto a body surface and one or more of the transducers is activatable to generate the waves in a direction perpendicular to the body surface.

16. The system according to claim 1, wherein the system is configured to activate the transducers at two or more frequencies and waveforms to maintain or manipulate the medium or materials within the medium.

17. A method for displacing or reforming a mass within a body medium comprising:
(c) applying one or more tactile audio transducers to the medium; and
(d) driving one or more of the tactile audio transducers to generate audio waves in the medium to cause displacement of the mass or reformation of the mass.
